(19) United States
(12) Patent Application Publication
(10) Pub. No.: US 2011/0009613 A1
(43) Pub. Date: Jan. 13, 2011

(54) METHOD OF PROCESSING BETA-GLUCAN

(75) Inventors: Anu Kaukovirta-Norja, Espoo (FI); Pekka Lehtinen, Veikkola (FI); Ilkka Virkajärvi, Espoo (FI); Mikko Suortti, Espoo (FI); Olavi Myllymäki, Espoo (FI); Jari Helin, Rajamaki (FI); Anne Olonen, Lahti (FI)

Correspondence Address: BIRCH STEWART KOLASCH & BIRCH, PO BOX 747, FALLS CHURCH, VA, 22040-0747, US

(73) Assignee: Valtion Teknillinen Tutkimuskeskus, Espoo (FI)

(21) Appl. No.: 12/747,737

(22) PCT Filed: Dec. 18, 2008
(86) PCT No.: PCT/FI08/50768

§ 371 Date: Sep. 7, 2010

(30) Foreign Application Priority Data
Dec. 19, 2007 (FI) 20070993

(51) Int. Cl. C08B 37/00

(52) U.S. Cl. 536/123.12

(57) ABSTRACT

The invention relates to a method of degrading plant-based β-glucan into a controlled molecular size by hydrolyzing β-glucan in a closed space under pressure by means of an acid at an elevated temperature. The invention also relates to a degraded β-glucan product. The β-glucan product obtained is useful in foodstuffs applications, such as beverages.

### BACKGROUND OF THE INVENTION

The invention relates to degrading plant-based β-glucan in a controlled manner into a desired molecular size, the molecular size distribution thereof being typically within a narrow range. The method of the invention enables the controlled adjustment of the molecular weight of β-glucan and, thus, the improvement of the solubility and stability of β-glucan in various foodstuffs, such as beverages. The β-glucan used in the method of the invention is typically cereal-based β-glucan. The invention also relates to a degraded β-glucan product. The invention still further relates to the use of β-glucan products obtained with the method for preparing β-glucan-containing foodstuffs, such as beverages.

β-glucan is added as a health-affecting component to many foodstuffs, such as yoghurts, bakery products (e.g. snacks) and various beverages. The β-glucan concentrates used as the starting material in the manufacture of β-glucan beverages, for example, are generally manufactured by extracting into water and separating the water-soluble fibre fraction generated from the β-glucan from the water-insoluble fibre.

Cost-effective manufacture of β-glucan beverages requires that β-glucan can be dissolved from the solid phase into the liquid phase with an optimally high yield. In order to provide the β-glucan with the desired physiological effect, such as a reduction in the blood cholesterol content, the content thereof in the beverage should be sufficient, i.e. about 3 to 5 g per dose. This requires that the high molecular weight (1 to 2×10⁶ g/mol) of the native β-glucan in the cereal material can be lowered in a controlled manner to a level of 5,000 to 360,000 g/mol. With such a molecular size, the desired β-glucan content can be achieved without the viscosity increasing too high (100 to 150 mPas), which complicates the drinking of the beverage.

Several studies have been made on the degrading of β-glucan. Generally, the tests have been performed by using purified β-glucan extracted from a cereal matrix, and the hydrolysis has been performed in an aqueous solution with acid, such as hydrochloric acid (Tosh et al., 2003), or enzymatically (Roubroeks et al., 2001), the purpose being to determine the structure of the molecules. The molecular weight M_{W} of degraded β-glucan obtained by acid hydrolysis was 70,000 to 40,000 g/mol (Tosh et al.) and the molecular weight M_{W} of the product obtained by enzymatic hydrolysis was within the range 2,200 to 213,900 g/mol (Roubroeks et al.). Publication Johansson et al. (2006) compares, in an analytical sense, acid hydrolysis (HCl, TFA and H₂SO₄) and enzymatic hydrolysis with the lichenase enzyme of pure β-glucan isolated from oat.

Publication WO 2004/086878 (Zheng, G-H et al., Gargill Incorporated, 2004) discloses a process of reducing the molecular weight of β-glucan by digesting β-glucan-containing flour into large amounts of water (e.g. 10 g/l), to which aqueous solution enzymes had been added. The β-glucan was then precipitated from the large amount of water with 92-% ethanol. The molecular weights M_{W} of the β-glucans obtained varied between 50,000 and 1,000,000 g/mol, e.g. between 120,000 and 170,000 g/mol.

Publication US 2004/0001907 A1 (Vasanthan, T. et al., 2004) discloses a method of preparing a β-glucan product by mixing β-glucan-containing flour and alcohol into a flour/alcohol slurry, separating the fibre-containing residue from the alcohol, re-extracting the fibre-containing residue into alcohol, and subjecting the thus obtained slurry to sonication or treatment with protease or amylase, thus yielding the desired β-glucan product. The publication also discloses a method of adjusting the fragmentation degree of β-glucan by using sonication in a water/alcohol solution by varying the ratio of water/alcohol.

Publication WO 2005/120251 (Löv, J. et al., Oy Glubikan Ab) discloses a method of extracting β-glucan from cereal by adjusting the pH of moist cereal to less than 5.2 with acid, followed by treating the cereal in a closed space under pressure (less than 5 bar) at a temperature of 100 to 130° C., followed by separating the aqueous phase from the solid matter and separating the β-glucan from the aqueous phase. The dry matter content in the extraction is preferably 7 to 10% and the time of treatment typically 10 to 20 minutes. The cereal material to be treated may be milled or it may be in the form of whole grains.

Publication U.S. Pat. No. 6,210,722 (Wullschleger, R. D. et al., Kellog Company, 2001) discloses a method of preparing a fibre-containing product by wet-extruding (at a moisture of e.g. 25 to 45%) and simultaneously cooking a mixture containing a soluble fibre source and an insoluble fibre source, and by drying the thus obtained extrudate to a water content of from 3 to 12%. The soluble fibre may be β-glucan or psyllium, for example. The dry extrudate was milled and admixed into beverages, among other things.

Publication WO 2006/040395 A1 (Laakso, S. et al., Ravintoraisio Oy, 2006) discloses a method for preparing a liquid fibre composition containing grain-based dietary fibre by mixing the fibre material with an aqueous medium and by homogenizing the mixture for reducing the viscosity thereof. The thus obtained homogenous mixture can further be heated. The fibre material of the mixture contains both a soluble and an insoluble component, whereby the soluble component may be β-glucan, for example.

In the present invention, the intention is to improve the degrading of β-glucan in a manner yielding stable β-glucan degraded in a controlled matter, which can be dissolved for instance in beverages with a better yield than in known methods.

### BRIEF DESCRIPTION OF FIGURES

FIG. 1. Proton NMR spectra of soluble β-glucan fractions. (A) β-glucan fraction prepared as described in this application, (B) β-glucan fraction obtained from a major supplier brand. Both fractions were obtained by treating the water soluble part of β-glucan powders with amyloglucosidase followed by dialysis to remove excess starch. Spectra were measured with Varian Unity spectrometer at 500 MHz at 10° C. in deuterium oxide containing trace of acetone as an internal standard (2.225 ppm). The signals assigned to β-glucan chain residues (Glcβ1,4 and Glcβ1,3) are indicated in the figure.

### BRIEF DESCRIPTION OF THE INVENTION

The invention relates to a method of degrading plant-based β-glucan in a controlled and reproducible manner into a desired molecular size, providing products containing degraded β-glucan, wherein the molecular weight distribution of β-glucan is typically narrow. The invention also relates to the use of β-glucan-containing products obtained with the method in the manufacture of β-glucan-containing foodstuffs, such as beverages. The β-glucan used as the starting material is typically concentrated β-glucan isolated from cereal, such as barley or oat.

The present invention further relates to degraded β-glucan with a Glcβ1,4:Glcβ1,3 ratio that is the same as the Glcβ1,4:Glcβ1,3 ratio in native β-glucan.

The method of the invention enables the adjustment of the molecular weight of β-glucan by subjecting plant-based native β-glucan to hydrolysis in the form of a flour or a doughy mass in a closed space under pressure in the presence of an acid solution at an elevated temperature by adjusting the temperature and the time of the hydrolysis and the concentration of the acid solution.

The method of the invention also enables the improvement of the solubility and the stability of the obtained β-glucan in foodstuffs, such as beverages.

### DETAILED DESCRIPTION OF THE INVENTION

The invention relates to a method of controlled degrading of plant-based β-glucan into a reduced molecular size by subjecting the β-glucan to hydrolysis in a flour like form or the form of a doughy mass in a closed space under pressure in the presence of an acid solution at an elevated temperature followed by cooling, to obtain a product containing degraded β-glucan.

The polydispersity M_{W}/Mₙ, which is descriptive of the molecular weight distribution, of the molecular weight of the β-glucan in the obtained, degraded β-glucan product is typically less than 10, preferably less than 8 and particularly less than 5. The lower the value of the polydispersity, the lower the molecular weight distribution.

The average molecular weight M_{W} of degraded β-glucan is within the range 5,000 to 360,000 g/mol, preferably from 10,000 to 100,000 g/mol and particularly from 20,000 to 50,000 g/mol.

In the context of the present invention, the above molecular weights M_{W} and Mₙ refer to the average molecular weight (M_{W}) weighted in relation to the weights of the molecules and the average molecular weight (Mₙ) weighted in relation to the number of molecules.

The plant-based β-glucan used as raw material (native β-glucan) in the invention may be any plant-based β-glucan preparation. Typically β-glucan is cereal-based β-glucan, preferably oat-based or barley-based β-glucan. Particularly preferably, the raw material used is cereal-based, such as an oat-based or barley-based β-glucan concentrate having a β-glucan content of more than 10%. Mechanical dry methods, such as milling, sieving and air classification, for example, can be used for the preparation of such a β-glucan concentrate from cereal. Accordingly, the raw material may be for instance a floury oat or barley fibre concentrate obtained as a coarse fraction with said dry methods and having a β-glucan content of for example 15 to 50%, a fat content of 1 to 8% and a protein content of 15 to 30%.

β-glucan means linear polymer of alternating □3- and □4-linked glucose (D-Glc) residues. The preferred β-glucan structures are according to formula [Glcβ4]ₜ{Glcβ3[Glcβ4]ₙ}ₘ[Glcβ3]ₗ[Glcβ4]ₖGlc, wherein n is an integer from 2-4, preferably from 2-3, m is an integer from 1-2000 indicating the number of repeating units, t is an integer from 0 to 4 indicating the non-reducing end Glcβ4 residue, l is an integer from 0 to 1 indicating Glcβ3 closest to the reducing end, and k is an integer from 0 to 4, preferably 0 to 3, most preferably 0 to 2 indicating Glcβ4-units closest to the reducing end. In a preferred embodiment the reducing end Glc is in reducing form having alfa- and β anomeric forms in water solution and there are local variations in the length of the [Glcβ4] n units, so that n may have different values at each position of the linear chain.

β-glucan with reduced molecular size is referred to as degraded β-glucan.

The invention is especially directed to degraded β-glucans which are preferably produced by acid hydrolysis under conditions according to the invention. It is realized that these conditions give special random hydrolysis of glycosidic linkages and thus have different composition than enzymatically degraded glucans, in which typically specific Glcβ4Glc-linkages with distance to Glcβ3Glc-units are degraded. The present invention therefore also provides a degraded β-glucan where the Glcβ1,4:Glcβ1,3 ratio is the same as the Glcβ1,4:Glcβ1,3 ratio in native β-glucan. Acid hydrolysis randomly degrades the glycosidic linkages and therefore a degraded β-glucan with a preserved glycosidic linkage ratio is obtained. It is advantageous that the degradation of the β-glucan does not alter the structural characteristics of the β-glucan. If the structural characteristics such as the glycosidic linkage ratio are altered the health beneficial properties of β-glucan might be diminished or even completely lost. A degraded β-glucan with improved physiological characteristics, such as solubility, without changing the structural characteristics is therefore provided.

The β-glucan preparations used as raw material typically contain not only β-glucan, but also insoluble cereal fibre, for example.

In such floury cereal-based β-glucan concentrates, the β-glucan is located in the cell walls of aleurone and subaleurone tissues and endosperm of the coarse fractions obtained by classification or sieving, from where it has to be extracted into a solution for foodstuff applications. In the processing according to the present invention, the cell wall structure of the native β-glucan in the cereal matrix is modified in closed system with heat and/or thermomechanical energy, and the molecular weight of the native β-glucan is degraded by thermo-catalytic acid hydrolysis.

According to present invention the depolymerisation of β-glucan is done by effectively moisturizing β-glucan containing flour with acidic water solution and keeping the oat bran concentrate elevated temperature desired retention time.

When water is added to the β-glucan containing flour to increase the moisture content approximately to the range of 25 to 40%, it retains the flour like properties and is free flowing, has a high porosity and there is little agglomeration of particles. This type of material is here referred to be in flour like form. When the water content is increased to approximately 40 to 70%, the flour will produce a plasticized mass that has a high viscosity, is not free flowing and has higher density and lower porosity than the flour in the flour like form. This type of material is here referred to be in the form of a doughy mass.

The acid may be any acid suitable for use in food processing industry and is preferably hydrochloric acid or phosphorus acid. The acid is mixed in β-glucan containing flour by effectively mixing acid and concentrate so that the concentrate of the acidic solution is evenly absorbed into fibre particles. This step is here referred as a preconditioning. The preconditioned material is then heated in a closed vessel at an elevated temperature while maintaining the preset moisture content. This step is here referred to as a heat treatment. The decrease of the molecular weight of β-glucan depends of the concentration of acid and the retention time at selected temperature in closed system. After suitable reaction time the flour is dried on a fluid bed drier or a band dryer.

The amount of acid water added to the flour in the preconditioning step is 25%-40% calculated on total mass of material.

The acid concentration of water solution used in preconditioning is 0,3-1,5% of hydrochloric acid or 1-4% in phosphoric acid.

The heat treatment method of the invention can be performed in different types of closed devices provided with heating and pressure adjustment means with or without mixing. When the method is implemented as continuous process, the devices shall also be provided with means for introducing the different reactants into the device and for removing the reaction products from the device. Suitable devices include pressure vessels, expanders and extruders, for example. In case the preconditioned flour was heat treated in extruder or a like equipment, flour was further moisturized during the extrusion process by adding 0,3 kg acid water per 1 kg flour.

In a preferred embodiment, the method is carried out by extruding in an extrusion device. In this case, a suitable hydrolysis reactor is for example a double-screw extruder, whose parameters are easy to adjust. The screw structure of a double-screw extruder comprises mixing disks and blocking screw elements. These admix the reactants introduced into the device, i.e. the β-glucan flour and the acid solution, and compress it into a plastic, homogenous, doughy mass. The mixing discs and the blocking screw elements are preferably located in such a manner that the degree of filling of the extruder and, consequently, the heat transfer between the plastic, homogenized, doughy mass and the heated tube wall is as effective as possible. The tube of the extruder has to be provided with independent temperature elements, which contain not only heating, but also cooling, and with which a suitable temperature profile can be adjusted.

The β-glucan used as raw material is introduced into a hydrolysis device, such as an extrusion device, typically as a dry or preconditioned feed in a floury form. The method is preferably carried out as a continuous method, whereby the raw material is introduced into the device at a constant speed (g/min).

A suitable acid for use in the hydrolysis of the invention is phosphoric acid, for example. The phosphoric acid is introduced into the hydrolysis device as an aqueous solution, wherein the content of phosphoric acid is typically within the range 2 to 15%, preferably 3 to 10% (w/w). After the dry feed of the raw material, i.e. a β-glucan concentrate, the acid solution is introduced into the hydrolysis device, in a continuous method typically at a constant speed (g/min). The mixing means of the hydrolysis device admix the β-glucan flour and the acid solution and compress it into a plastic, homogenous, doughy mass.

The hydrolysis treatment, as the extrusion, is typically carried out at a temperature of 80 to 150° C., at 145° C., for example. Heating, for instance in an extrusion device, may be achieved with heated tube elements of the extrusion device, whereby the heat is transferred during mixing from the tube elements to the plastic mass. The viscosity of the mass is reduced, the starch is gelatinized and hydrolyzed, the enzymes become inactive, the proteins denature, and β-glucan is hydrolyzed. In the extruder, the hydrolyzing degree can be controlled typically with mechanical specific energy.

The hydrolysis time, i.e. the residence time in the hydrolysis device, such as in an extrusion device, is short, typically 0.5 to 3 minutes, about 1 minute, for example. The residence time can be adjusted with the mass flow introduced into the hydrolysis device, the flow being composed of a dry matter feed and an acid solution feed. The hydrolysis is typically carried out at a water content of 30 to 60%, preferably at a water content of 30 to 50% (w/w). In this water content, the molecular weight of the native β-glucan concentrated into the cereal matrix can be preferably reduced to a suitable level in a controlled manner. The preferable water content of 30 to 50% used is lower than that usually used in the field in enzymatic depolymerization processes of β-glucan.

Correspondingly, the dry matter content of the extrusion mass is high, i.e. within the range 30 to 70%, preferably 50 to 70% (w/w).

The pressure used in the hydrolysis is typically within the range 1.5 to 10 bar.

The hydrolysis reaction is highly dependent on temperature and time, and consequently control of the reaction requires good temperature and residence time adjustment of the reactor.

The hydrolysis reaction is stopped or the propagation speed thereof is significantly slowed down by cooling. The cooling is typically performed to a temperature of less than 40° C. When the hydrolysis is carried out in an extruder, cooling is typically implemented by cooling the plastic, doughy mass exiting the extruder with a specific cooling die. This is for example a tube heat exchanger serving as the die, wherein cold water circulating in the jacket of the die serves as the cooling medium.

When the hydrolysis is performed in a pressurized container the hydrolysis time is 0.5 to 48 h.

The method of the invention reduces the process time and improves the yield of β-glucan. The method does not use enzymes, which may cause costs in the process.

Since the hydrolysis reaction is highly temperature-dependent, a longer residence time may result in a hydrolysis degree at a lower temperature, which would require a higher temperature with a shorter residence time. Similarly, by lengthening the residence time, the desired hydrolysis effect may be achieved at a lower acid concentration.

From the hydrolysis, a product containing degraded β-glucan is obtained in the form of a plastic, doughy mass, wherein the polydispersity of the molecular weight of β-glucan is typically less than 10, preferably less than 8 and particularly less than 5. The average molecular weight M_{W} of degraded β-glucan is within the range 5,000 to 360,000 g/mol, preferably from 10,000 to 100,000 g/mol and particularly from 20,000 to 50,000 g/mol. The thus obtained product can be used for further applications as such or after drying. In addition to β-glucan, the product contains, among other things, the acid used in the hydrolysis (e.g. phosphoric acid or hydrochloric acid) and components of the cereal matrix.

In further process steps, the β-glucan product obtained from the hydrolysis may be subjected for instance to one or more of the following procedures in the desired order: mixing the acid solution, neutralization with a base, drying, extraction with water, separation of dry matter, activated charcoal treatment, a new acid hydrolysis, thermal stabilization and/or precipitation with ethanol. In this manner, different β-glucan products are obtained, which may be in a solid or a liquid form depending on the treatment method, they may contain phosphoric acid used in the acid hydrolysis or be neutralized, they may contain insoluble fibre of the cereal matrix or said insoluble fibre may be removed, and the molecular size of the β-glucan contained therein may be further reduced by using a new acid hydrolysis or ethanol precipitation. The thus obtained β-glucan products are useful in foodstuffs, as beverage constituents to be admixed in different beverages, for example. At the same time, valuable side products are obtained, which are useful for use in animal feed or manure, for example.

In an embodiment of the invention, neutralization with a base can be performed already in the hydrolysis device, by introducing a base into the device after the hydrolysis reaction before the cooling step. Calcium hydroxide, for example, can be used as the base. This procedure is particularly well suited when the hydrolysis is performed in an extruder, for example. A neutralized product containing degraded β-glucan is obtained, wherein the average molecular weight of the β-glucan is within the above-described range. The product also contains insoluble fibre of the cereal and other insoluble components of the raw material.

In an additional embodiment of the invention, the β-glucan product (which may be neutralized) obtained from the hydrolysis is dried, whereby a dried β-glucan product is obtained, wherein the molecular weight of the β-glucan is within the above-described range. The product obtained is a β-glucan-containing semi-finished product useful for different foodstuffs applications. This product contains insoluble cereal fibre, and the inherent flavour and the light colour of the cereal used as the starting material, e.g. barley, remain in the product.

In another embodiment of the invention, the β-glucan product obtained from the hydrolysis is subjected to extraction with water, in a dry matter content of 5 to 20%, for example. The extraction is typically performed at a low temperature (e.g. below 60° C.) by simultaneously mixing under strong shearing forces. Dry matter containing the insoluble fibre of the cereal, among other things, is separated from the extraction mixture. The separation may be performed by centrifugation or filtration, for example. A β-glucan solution is obtained, in which the average molecular weight of the β-glucan is within the above-described range and which does not contain insoluble fibre. The separated insoluble dry matter is useful for use as feed, for example.

The solution obtained from the extraction may be subjected to clarification and treatment with activated charcoal, if desired.

The (optionally clarified) solution obtained from the extraction contains acid used in the hydrolysis, such as phosphoric acid, and it may be neutralized with a base, calcium hydroxide, for example. In the neutralization, the pH of the solution is increased to the final value, 6.5, for example. Dry matter is separated from the neutralization mixture by filtration, for example. When phosphoric acid is used as the hydrolysis acid, the dry matter obtained is mainly calcium phosphate. The separated calcium phosphate may be recovered and used as a fertilizer, for example. The β-glucan solution obtained after the separation of the dry matter can be stabilized by UHT treatment, for example. A neutralized, stabilized β-glucan solution is obtained, in which the molecular weight of the β-glucan is within the above-described range and which does not contain insoluble fibre. The solution is useful as a beverage constituent to be admixed in different beverages, for example.

In an additional embodiment of the invention, the method may further comprise a second acid hydrolysis for further reducing the average molecular weight M_{W} of the β-glucan, to the range 5,000 to 50,000 g/ml, for example. This second acid hydrolysis is usually performed after the above-described water extraction and dry matter (insoluble fibre) separation. Said second acid hydrolysis is generally performed as a conventional acid hydrolysis at an elevated temperature (e.g. 90° C.). The hydrolysis time may be one hour, for example. The acid used in the hydrolysis may be the same as that used in the first hydrolysis step.

The thus obtained further-hydrolyzed β-glucan product may be further processed in the same way as above by clarifying, neutralizing and separating the solid matter. This can be followed by dewatering for instance by film filtration or evaporation, after which the concentrated mass obtained may be stabilized with UHT treatment, for example. A neutralized β-glucan product is obtained, in which the average molecular weight M_{W} of the β-glucan is typically within the range 5,000 to 50,000 g/mol and which does not contain insoluble fibre. The product is useful as a beverage constituent to be mixed in different beverages, for example.

From the thus obtained β-glucan product, wherein the average molecular weight M_{W} of the β-glucan is in the order of 20,000 g/mol, for example, the β-glucan may be precipitated by ethanol treatment. The precipitation may be performed for instance with about 80-% ethanol with simultaneous mixing. The solid precipitate is separated from the solution, extracted with water with simultaneous heating, and the insoluble solid matter is separated (for use as feed, for example). The obtained β-glucan-containing solution may be stabilized, yielding a β-glucan solution, in which the average molecular weight M_{W} of the β-glucan is typically within the range 2,000 to 20,000 g/mol. The product is useful as a beverage constituent to be mixed in different beverages, for example.

The invention also relates to the use of the β-glucan products obtained with the method of the invention as a functional supplement in the manufacture of foodstuffs, such as processed food, bakery products (e.g. snacks), milk products (e.g. yoghurts), spreads and beverages, such as health beverages and berry juices. The manufacture of beverages and other foodstuffs by using a β-glucan product obtained with the method of the invention as a functional supplement takes place in manners known per se.

It was found that the characteristics of β-glucan, including molecular weight, remained unchanged when β-glucan preparations manufactured by the method of the invention were admixed with foodstuffs, such as beverages. It was also found that the solubility of β-glucan had improved, i.e. the use of β-glucan preparations manufactured by the method of the invention allowed more β-glucan to be dissolved into the beverages. When the method of the invention is used, a large amount of the plant-based β-glucan will thus be in a soluble form. Beverages were manufactured, whose β-glucan content was up to 5%.

The invention further provides a degraded β-glucan having an average molecular weight M_{W} within the range 5,000 to 360,000 g/mol, in which the Glcβ1,4:Glcβ1,3 ratio is the same as the Glcβ1,4:Glcβ1,3 ratio in native β-glucan, preferably the Glcβ1,4:Glcβ1,3 ratio is 2-3:1. The degraded β-glucan preferably has an average molecular weight M_{W} within the range 10,000 to 100,000 g/mol, and preferable within the range 20,000 to 50,000 g/mol and the polydispersity M_{W}/Mₙ of the molecular weight of the degraded β-glucan is less than 10, preferably less than 8 and particularly less than 5.

The following examples are intended to illustrate, not restrict the invention in any way.

The following starting materials, devices and general methods were used in the examples:

The tests were performed in an APV 19/25 double-screw extruder (manufacturer APV). Four different β-glucan concentrates were introduced into the extruder: (1) an β-glucan containing flour having a β-glucan content of 22% (manufacturer Raisio Group), (2) β-glucan containing flour with 33% β-glucan content manufactured according VTT method (as described in WO/2008/096044), (3) Viscofiber fibre concentrate having a β-glucan content of 50% (manufacturer Cevena), (4) Polycell barley fibre having a β-glucan content of 22% (manufacturer Polycell). The residence time in the extruder was ti to 1.3 min.

The molecular weight of the β-glucan obtained from the extruder was assessed as an average molecular weight M_{W} weighted in relation to the weight of the molecules and as an average molecular weight Mₙ weighted in relation to the number of molecules. These were assessed by means of size exclusion chromatography on the basis of pullulan standards, unless otherwise stated.

The beverage applications were manufactured by suspending the hydrolyzed β-glucan-containing fibre mass obtained from the extruder into water or a 0.4 w-% phosphoric acid to a concentration of 7 to 20 w-%. The pH of the aqueous solution in the extraction was between 2.5 and 4.

The thus obtained mixture was mixed for 15 to 30 seconds with a mixer provided with a shearing blade. The β-glucan fraction was separated from the insoluble husk and the like material by means of centrifugal force (2,000 to 3,000 G). The obtained aqueous solution fraction was clarified by filtering it through a paper filter or the like, for example, for instance by filtering it by means of water suction through a Whatman 3 filter paper. The phosphorus in the solution was precipitated with Ca(OH)₂ and separated from the solution either with a centrifuge or by filtration.

The amount of filtered β-glucan solution was 1.5 to 5-fold per extruded fibre mass. The proportion of β-glucan of the soluble dry matter was about 50% and its content in the solution may be 1 to 5%.

### Example 1

Oat fibre having a β-glucan content of 22% from Raisio Yhtymä was used as the starting material. The speed of introduction of the flour into the extruder was 20 g/min in non-preconditioned trials. The oat fiber was preconditioned with 0.3 kg of 8% H₃PO₄ per 1 kg oat fiber at 40° C. for 1 h in VTT pre-conditioner made by Auran Metalli LTD. The temperature of the heating element at the feeding point of the tube was 85° C. and the temperatures of the next three heating elements from the inlet towards the die were varied. The speed of rotation of the extruder screws in all tests was 75 rpm. The extrusion product was cooled with a heat exchanger die.

The test conditions are presented in Table 1. Temperatures T1→T4 are the extruder tube heating zones starting from the die. The dry matter contents in the extrusion were about 50 to 57%. The feed of preconditioned oat fiber was 28 g/min and the amount of 8% H₃PO₄-solution 12 g/min.

Table 1 shows the molecular weight distributions of the β-glucan of the extrudates obtained as a function of the extrusion parameters.

TABLE 1
Raisio oat fibre (22% β-glucan): process conditions and obtained molecular weights of β-glucan.

| | T1 | T2 | T3 | T4 | | | | |
|---|---|---|---|---|---|---|---|---|
| Acid feed | ° C. | ° C. | ° C. | ° C. | rpm | M̅w̅ | M̅n̅ | Polydispersity |
| 20 ml/min (* | 130 | 130 | 130 | 85 | 75 | 180000 | 30000 | 6 |
| 4-% H₃PO₄ | | | | | | | | |
| 15 ml/min (* | 130 | 130 | 130 | 85 | 75 | 65000 | 15000 | 4.3 |
| 8-% H₃PO₄ | | | | | | | | |
| 15 ml/min (* | 140 | 140 | 140 | 85 | 75 | 120000 | 25000 | 4.8 |
| 4-% H₃PO₄ | | | | | | | | |
| 12 ml/min | 110 | 110 | 110 | 85 | 75 | 135 000 | 17 500 | 7.8 |
| 8-% H₃PO₄ | | | | | | | | |
| 12 ml/min | 120 | 120 | 120 | 85 | 75 | 110 000 | 16 000 | 6.9 |
| 8-% H₃PO₄ | | | | | | | | |
| 12 ml/min | 130 | 130 | 130 | 85 | 75 | 45 000 | 6 500 | 6.9 |
| 8-% H₃PO₄ | | | | | | 36 500 | 5 000 | 7.3 |
| | | | | | | 55 000 | 7 500 | 7.3 |
| 12 ml/min | 145 | 145 | 145 | 85 | 75 | 26 000 | 4 500 | 5.8 |
| 8-% H₃PO₄ | | | | | | 26 000 | 4 500 | 5.8 |
| 12 ml/min | 155 | 155 | 155 | 85 | 75 | 19 000 | 4 000 | 4.8 |
| 8-% H₃PO₄ | | | | | | 13 500 | 3 000 | 4.5 |
| | | | | | | 25 000 | 4 500 | 5.6 |

(* The first three trials were made without preconditioning

### Example 2

The following hydrolysate used an β-glucan containing flour manufactured by VTT method (WO/2008/096044). Its β-glucan content was 33% and the molecular weight of β-glucan (M_{W}) was 950 000 g/mol. The results are shown in Table 2, the β-glucan containing flour was first preconditioned with 8% H₃PO₄-solution, which was added in an amount of 0.3 g/g fiber concentrate. The feed of preconditioned oat fiber was 24 g/min and the amount of 8% H₃PO₄-solution 12 g/min.

TABLE 2
β-glucan containing flour containing 33% β-glucan manufactured by VTT method
(WO/2008/096044): process conditions and obtained molecular
weights of β-glucan.

| | T1 | T2 | T3 | T4 | | | | |
|---|---|---|---|---|---|---|---|---|
| Acid feed | ° C. | ° C. | ° C. | ° C. | rpm | M̅w̅ | M̅n̅ | Polydispersity |
| 12 ml/min | 110 | 110 | 110 | 85 | 75 | 105 000 | 28 500 | 3.7 |
| 8-% H₃PO₄ | | | | | | | | |
| 12 ml/min | 120 | 120 | 120 | 85 | 75 | 80 000 | 18 500 | 4.3 |
| 8-% H₃PO₄ | | | | | | 55 000 | 11 500 | 4.8 |
| 12 ml/min | 130 | 130 | 130 | 85 | 75 | 45 000 | 10 500 | 4.3 |
| 8-% H₃PO₄ | | | | | | 40 000 | 7 500 | 5.3 |
| | | | | | | 27 500 | 5 00 | 5.5 |
| 12 ml/min | 145 | 145 | 145 | 85 | 75 | 20 000 | 4 750 | 4.2 |
| 8-% H₃PO₄ | | | | | | 20 00 | 5 000 | 4.0 |
| 12 ml/min | 155 | 155 | 155 | 85 | 75 | 15 000 | 3 750 | 4.0 |
| 8-% H₃PO₄ | | | | | | 15 000 | 3 500 | 4.3 |
| | | | | | | 12 500 | 3 500 | 3.6 |

To decrease the molecular weight of β-glucan further, the preconditioned β-glucan containing flour (33% β-glucan) was preconditioned (0.3 g of 8% H₃PO₄ per 1 g oat fiber at 40 C for 1 h) and extruded with more concentrated acid as explained in Table 3. The feed of the preconditioned oat fiber was 24 g/min. The amount and concentration of H₃PO₄-solution was changed from 12 to 3 ml/min and from 8% to 32%, respectively, the temperature was 130 or 155° C.

TABLE 3
β-glucan containing flour containing 33% (β-glucan (VTT): process conditions and obtained molecular
weights of β-glucan.

| | T1 | T2 | T3 | T4 | | | | |
|---|---|---|---|---|---|---|---|---|
| Acid feed | ° C. | ° C. | ° C. | ° C. | rpm | M̅w̅ | M̅n̅ | Polydispersity |
| 12 ml/min | 130 | 130 | 130 | 85 | 75 | 19 500 | 2 500 | 7.8 |
| 8-% H₃PO₄ | | | | | | | | |
| 9 ml/min | 130 | 130 | 130 | 85 | 75 | 20 000 | 3 000 | 6.7 |
| 8-% H₃PO₄ | | | | | | | | |
| 6 ml/min | 130 | 130 | 130 | 85 | 75 | 32 000 | 4 500 | 7.1 |
| 8-% H₃PO₄ | | | | | | | | |
| 12 ml/min | 155 | 155 | 155 | 85 | 75 | 11 500 | 2 000 | 5.8 |
| 8-% H₃PO₄ | | | | | | | | |
| 9 ml/min | 155 | 155 | 155 | 85 | 75 | 11 500 | 2 000 | 5.8 |
| 8-% H₃PO₄ | | | | | | | | |
| 6 ml/min | 155 | 155 | 155 | 85 | 75 | 10 000 | 2 000 | 5.0 |
| 8-% H₃PO₄ | | | | | | | | |
| 3 ml/min | 155 | 155 | 155 | 85 | 75 | 8 500 | 2 000 | 4.3 |
| 8-% H₃PO₄ | | | | | | | | |
| 9 ml/min | 155 | 155 | 155 | 85 | 75 | 10 000 | 2 000 | 5.0 |
| 10-% H₃PO₄ | | | | | | | | |
| 6 ml/min | 155 | 155 | 155 | 85 | 75 | 7 000 | 1 500 | 4.7 |
| 16-% H₃PO₄ | | | | | | | | |
| 3 ml/min | 155 | 155 | 155 | 85 | 75 | 5 000 | 1 500 | 3.3 |
| 32-% H₃PO₄ | | | | | | | | |

### Example 3

The third β-glucan-containing material to be hydrolyzed was commercial Cevena Viscofiber fibre having a β-glucan content of 50%. Two tests were performed with the fibre. The floury fibre raw material was introduced into the extruder at a speed of 20 g/min, the feed of acid solution being 20 ml/min. 8-% phosphoric acid. The extrusion was done without preconditioning.

In the following Table 4, temperatures T1→T4 are the extruder tube heating zones starting from the die. The dry matter contents in the extrusion were about 50%.

TABLE 4
Cevena Viscofiber oat fibre: process conditions
and obtained 5 molecular weights of β-glucan.

| Acid | T1 | T2 | T3 | T4 | | | | Poly- |
|---|---|---|---|---|---|---|---|---|
| feed | ° C. | ° C. | ° C. | ° C. | rpm | M_{w} | Mₙ | dispersity |
| 20 ml/ | 130 | 130 | 130 | 85 | 75 | 110 000 | 38000 | 2.9 |
| min 8-% | | | | | | | | |
| H₃ PO₄ | | | | | | | | |
| 20 ml/ | 130 | 145 | 145 | 85 | 75 | 65000 | 16000 | 3.9 |
| min 8-% | | | | | | | | |
| H₃ PO₄ | | | | | | | | |

The values were determined by means of size exclusion chromatography on the basis of pullulan standards.

### Example 4

The fourth fibre to be hydrolyzed was Polycell barley fibre having a β-glucan content of 22% and a (M_{W}) of 200,000.

The floury fibre raw material was introduced into the extruder at a speed of 20 g/min and the speed of feeding the 4-% phosphoric acid was 20 ml/min. There was no preconditioning.

In the following Table 5, temperatures T1→T4 are the extruder tube heating zones starting from the die. The dry matter contents in the extrusion were about 50%.

The molecular weights of Table 4 were determined by means of size exclusion chromatography by using calco-fluor colouring after the column together with a fluorescence detector. A calibration line for the molecular weight determinations was made by using known β-glucan standards whose molecular size was determined by laser light scattering.

TABLE 5
Polycell barley fibre: Process conditions and obtained molecular weights of β-glucan.

| | T1 | T2 | T3 | T4 | | | | |
|---|---|---|---|---|---|---|---|---|
| Acid feed | ° C. | ° C. | ° C. | ° C. | rpm | M_{w} | Mₙ | Polydispersity |
| 20 ml/min | 130 | 130 | 130 | 85 | 75 | 24 000 | 12 000 | 2 |
| 4-% H₃PO₄ | | | | | | | | |
| 20 ml/min | 120 | 120 | 120 | 85 | 75 | 43 000 | 22 000 | 1.95 |
| 4-% H₃PO₄ | | | | | | | | |
| 20 ml/min | 110 | 110 | 110 | 85 | 75 | 77 000 | 33 000 | 2.3 |
| 4-% H₃PO₄ | | | | | | | | |

### Example 5

The oat fiber manufactured by VTT method (WO/2008/096044) was preconditioned with an acid solution and heat treated as powder without mechanical energy and without plasticization at elevated temperature in a pressurized container.

TABLE 6
β-glucan containing flour containing 33% β-glucan (VTT): processed in a pressurized
container without mechanical energy and plasticization.

| Acid solution temperature | Moisture | | | |
|---|---|---|---|---|
| and time in | of powder | | | |
| preconditioning | % | M̅w̅ | M̅n̅ | Polydispersity |
| 0.1 M HCl/120 C./30 min | 33 | 355 000 | 88000 | 4 |
| 0.2 M HCl/120 C./30 min | 33 | 310 000 | 18 500 | 16.8 |
| 3-% H3PO4120 C./30 min | 33 | 260 000 | 70 000 | 3.8 |
| 0.2 M HCl/ 90 C./18 h | 40 | 215 000 | 60 000 | 3.5 |
| 0.3 M HCl/ 90 C./18 h | 40 | 160 000 | 45 000 | 3.7 |
| 0.2 M HCl/ 90 C./48 h | 30 | 135 000 | 35 000 | 3.8 |

### Example 6

### Nmr Analysis of β-Glucan Samples

A water soluble fraction of a 15 kD β-glucan fraction was prepared according to the method of the present invention. The preliminary analysis showed that it contained a significant amount of starch. To simplify NMR analysis of the soluble components, starch was removed by digestion with amyloglucosidase followed by dialysis to remove the low MW products thus generated as follows: 100 mg of the β-glucan was dissolved in 10 ml of 50 mM Na-acetate at pH 5.0. 16 U of amyloglucosidase (Aspergillus niger, Calbiochem) was added and the reaction was allowed to proceed overnight at +37° C. The reaction was stopped by boiling for 5 min. Low-molecular weight material was removed by dialysis against water using MWCO 2000 dialysis tubing. Prior to NMR analysis the sample was further purified by solid phase extraction in BondElut C18 (Varian, Inc.).

A β-glucan sample from a major brand was treated similarly to prepare comparative material. This β-glucan is prepared by enzymatic hydrolysis using a cellulase-type endo-glucanase.

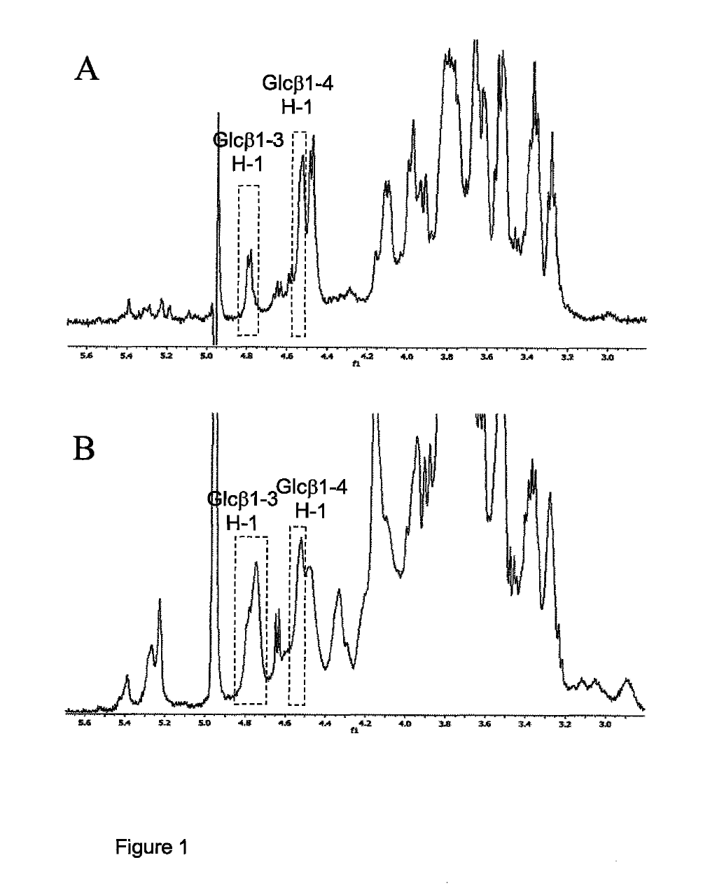

The NMR spectra of the β-glucan fractions are shown in FIG. 1. The β-glucan chain residues (Glcβ1,4 and Glcβ1,3) resonate at characteristic positions as shown in the Figure. By comparing the signal intensities it is possible to estimate the relative amount of the units in the β-glucan fractions. This type of analysis indicates that the acid hydrolyzed material (panel A) exhibits a Glcβ1,4:Glcβ1,3 ratio of about 2.5:1, while the major brand β-glucan manufactured by enzymatic process shows Glcβ1,4:Glcβ1,3 ratio close to 1:1.

The assignments in FIG. 1 were verified by 2-dimensional NMR analysis. COSY experiments showed that the Glcβ1,3H-1 signal at 4.75 ppm has a cross-peak at 3.37 ppm (Glcβ1,3H-2 signal). The Glcβ1,4 H-1 signal however showed two cross-peaks, 3.51 ppm and 3.35 ppm, indicating two non-identical H-2 units. These arise from the Glcβ1,4 residues which are substituted either by Glcβ1,4 or by Glcβ1,3 units. In a Glcβ1,3Glcβ1,4 sequence, the Glcβ1,4 residue showed H-2 signal at 3.51 ppm, while the 4-substituted Glcβ1,4 unit H-2 signal resides at 3.35 ppm.

The major signal partially overlapping with Glcβ1,4 H-1 signal in both spectra was assigned to xylan. The presence of xylose in these fractions was also verified by total acid hydrolysis of the material followed by monosaccharide analysis by high-pH anion-exchange chromatography.

### LITERATURE REFERENCES

Tosh, S. M. et al., Gelation characteristics of acid-hydrolyzed oat β-glucan solutions solubilized at a range of temperatures, Food Hydrocolloids, Vol. 17, No 4., 523-527, 2003.
Roubroeks, J. P. et al., Molecular weight, structure and shape of oat (1→3), (1→4)-β-D-glucan fractions obtained by enzymatic degradation with (1→4)-β-D-glucan 4-glucanohydrolase from Trichoderma reesei. Carbohydrate Polymers, Vol. 46, No 3., p. 275-285, 2001.
Johansson, L., et al., Hydrolysis of β-glucan, Food Chemistry, Vol. 97, No 1., p. 71-79, 2006.
WO 2004/086878 A2, Improved dietary fiber containing materials comprising low molecular weight glucan, Zheng, G-H. et al., Cargill Incorporated, publ. 14 Oct. 2004.
WO 2005/12051 A1, Method for extracting a cereal constituent, Löv, J. et al., Oy Glubikan Ab, publ. 22 Dec. 2005.
U.S. Pat. No. 6,210,722 B1, Extruded intermediates containing a soluble fiber and food products containing same, Wullschleger, R. D. et al., Kellog Company, granted 3 Apr. 2001.
US 2004/0001907 A1, Preparation of high viscosity β-glucan concentrates, Vasanthan et al., publ. 1 Jan. 2004.

1. A method of degrading plant-based β-glucan into a reduced molecular size in a controlled manner, characterized by subjecting the β-glucan to hydrolysis in a flour like form or in the form of a doughy mass in a closed space under pressure in the presence of an acid solution at an elevated temperature followed by cooling, thus yielding a degraded β-glucan product.

2. The method as claimed in claim 1, characterized in that the polydispersity M_{W}/Mₙ of the molecular weight of the degraded β-glucan is less than 10, preferably less than 8 and particularly less than 5.

3. The method as claimed in claim 1, characterized in that the average molecular weight M_{W} of the degraded β-glucan is within the range 5,000 to 360,000 g/mol, preferably within the range 10,000 to 100,000 g/mol, and particularly within the range 20,000 to 50,000 g/mol.

4. The method as claimed in claim 1, characterized in that the β-glucan is plant-based, preferably oat-based or barley-based β-glucan.

5. The method as claimed in claim 4, characterized in that the β-glucan is in the form of a β-glucan concentrate having a β-glucan content of more than 10%.

6. The method as claimed in claim 1, characterized by performing the hydrolysis by extrusion or in a pressurized container.

7. The method as claimed in claim 1, characterized in that the acid solution is a phosphoric acid solution.

8. The method as claimed in claim 7, characterized in that the concentration of the acid is 2 to 15%, preferably 3 to 10%.

9. The method as claimed in claim 1, characterized in that the elevated temperature is 80 to 150° C.

10. The method as claimed in claim 1, characterized in that the hydrolysis time is 0.5 to 3 min in extrusion and 0.5-48 h in a pressurized container.

11. The method as claimed in claim 1, characterized by performing the hydrolysis at a dry matter content of 30 to 70%, preferably 40 to 60%.

12. The method as claimed in claim 1, characterized by performing the hydrolysis at a water content of 30 to 60%, preferably 30 to 50%.

13. The method as claimed in claim 1, characterized in that the pressure is within the range 1.5 to 10 bars.

14. The method as claimed in claim 1, characterized by performing the cooling to a temperature of less than 40° C.

15. The method as claimed in claim 1, characterized in that the method further comprises neutralization with a base before cooling to yield a neutralized, degraded β-glucan product.

16. The method as claimed in claim 1, characterized by further subjecting the β-glucan product obtained to one or more of the following procedures in a desired order: mixing of the acid solution, neutralization with a base, drying, extraction with water, separation of solid matter, clarification, activated charcoal treatment, a new acid hydrolysis, heat stabilization and/or ethanol precipitation.

17. The method as claimed in claim 15, characterized by drying the β-glucan product obtained, yielding a dried product containing degraded β-glucan.

18. The method as claimed in claim 15, characterized by subjecting the β-glucan product obtained to extraction with water and separation of solid matter, yielding a solution containing degraded β-glucan and not containing insoluble fibre.

19. The method as claimed in claim 18, characterized by drying the β-glucan solution, yielding a dried product containing degraded β-glucan and not containing insoluble fibre.

20. The method as claimed in claim 16, characterized by subjecting the β-glucan solution to neutralization with a base and separation of solid matter, yielding a neutralized β-glucan solution not containing insoluble fibre.

21. The method as claimed in claim 17, characterized in that the average molecular weight M_{W} of the degraded β-glucan in the obtained products is within the range 5,000 to 360,000 g/mol, preferably within the range 10,000 to 100,000 g/mol and particularly within the range 20,000 to 50,000 g/mol.

22. The method as claimed in claim 18, characterized by subjecting the β-glucan solution to a new hydrolysis with an acid solution.

23. The method as claimed in claim 22, characterized by subjecting the β-glucan product obtained from the hydrolysis to neutralization with a base and separation of solid matter.

24. The method as claimed in claim 23, characterized by subjecting the β-glucan solution obtained from the neutralization to dewatering.

25. The method as claimed in claim 18, characterized by heat-stabilizing the product obtained.

26. The method as claimed in claim 20, characterized by precipitating the β-glucan product with ethanol, separating the precipitated β-glucan and extracting it in water.

27. Use of a β-glucan product obtained by a method as claimed in claim 1 as a functional supplement in the preparation of foodstuffs.

28. The use as claimed in claim 27, characterized in that the foodstuff is a beverage.

29. A degraded β-glucan having an average molecular weight M_{W} within the range 5,000 to 360,000 g/mol, characterized in that the Glcβ1,4:Glcβ1,3 ratio is the same as the Glcβ1,4:Glcβ1,3 ratio in native β-glucan.

30. The degraded β-glucan according to claim 29, characterized in that the Glcβ1,4:Glcβ1,3 ratio is 2-3:1.

31. The degraded β-glucan according to claim 29, characterized in that the average molecular weight M_{W} is within the range 10,000 to 100,000 g/mol, and preferable within the range 20,000 to 50,000 g/mol.

32. The degraded β-glucan according to claim 29, characterized in that the polydispersity M_{W}/Mₙ of the molecular weight of the degraded β-glucan is less than 10, preferably less than 8 and particularly less than 5.
